(19) United States
(12) Patent Application Publication
(10) Pub. No.: US 2011/0064429 A1
(43) Pub. Date: Mar. 17, 2011

(54) IMAGE FORMING APPARATUS AND IMAGE FORMING METHOD

(75) Inventors: Takao Izumi, Kanagawa-ken (JP); Hiroshi Murata, Tokyo-to (JP); Takashi Hatakeyama, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/871,062

(22) Filed: Aug. 30, 2010

Related U.S. Application Data
(60) Provisional application No. 61/242,992, filed on Sep. 16, 2009.

(51) Int. Cl. G03G 15/08; G03G 15/00

(52) U.S. Cl. 399/27; 399/44; 399/55; 399/49

(57) ABSTRACT

According to one embodiment, an image forming apparatus includes a developing unit configured to store a developer includes a toner and a carrier and to form a developer image, a toner attachment amount detection portion configured to detect an attachment amount of a toner formed on a photoconductor or an intermediate transfer body, a developing bias voltage change portion configured to change a plurality of developing bias voltages including a developing contrast voltage in a manner that the detected attachment amount of the toner becomes a value in a predetermined range, a carrier supply time correction portion configured to correct a carrier supply time in response to the value of the changed developing contrast voltage, and a carrier supply portion configured to supply a carrier in a corrected carrier supply time at a predetermined timing.

### CROSS-REFERENCE TO RELATED APPLICATIONS

This application is based upon and claims the benefit of U.S. Provisional Application No. 61/242,992, filed on Sep. 16, 2009; the entire contents of which are incorporated herein by reference.

### FIELD

Embodiments described herein relate generally to an image forming apparatus and an image forming method.

### BACKGROUND

Various developing apparatuses are used in an image forming apparatus such as a copier or a printer. For example, there is used a developing apparatus that performs the development using a two component developer. Generally, a developing apparatus, which uses the two component developer of a toner and a carrier, supplies the toner consumed by the development operation. However, although the toner is supplied, when the performance of the carrier declines, the performance for electrifying the toner deteriorates.

JP-A-6-348134 discloses a trickle developing method for suppressing the deterioration of the electrification performance of the toner due to the performance deterioration of the carrier. In the trickle developing method, a new carrier is supplied to the toner within a developing container, and the excessive developer is discharged from a discharge port. As a result, the new carrier is gradually replaced with the deteriorated carrier.

However, in the above-mentioned developing apparatus, the supply amount of the carrier into the developing container is decided depending on the toner amount to be consumed. For this reason, there was a case where the carrier of the required amount was not supplied, even though the deterioration of the carrier was noticeable. If the supply amount of the carrier is insufficient, the electrification shortage of the toner is generated. If the electrification shortage of the toner is generated, there is a high possibility in which the image quality of the developed toner image deteriorates or disadvantage such as a ground fog is generated. On the contrary, if the carrier is excessively supplied, the carrier with a low degree of deterioration is discharged, whereby the carrier is excessively consumed.

Thus, if the carrier can be suitably supplied into the developing container depending on the deterioration of the carrier, the clear developing image can be obtained without excessively consuming the carrier and the disadvantage such as the ground fog can be prevented to promote an improvement in image quality.

### BRIEF DESCRIPTION OF THE DRAWINGS

FIG. 1 is an exemplary schematic configuration diagram showing a color printer which is an image forming apparatus according to an embodiment.

FIG. 2 is an exemplary detailed configuration diagram showing respective process units according to an embodiment.

FIG. 3 is an exemplary perspective view showing a developing apparatus according to an embodiment.

FIG. 4 is an exemplary longitudinal sectional view showing a developing apparatus according to an embodiment.

FIG. 5 is an exemplary cross sectional view showing a developing apparatus according to an embodiment.

FIG. 6 is an exemplary longitudinal sectional view showing a developer supply unit and a developing apparatus according to an embodiment.

FIG. 7 is an exemplary block diagram showing a control system for controlling a new carrier supply to the respective developing apparatuses according to an embodiment.

FIG. 8 is a schematic exemplary functional configuration diagram showing a control system in an image forming apparatus according to an embodiment.

FIG. 9 is an exemplary diagram showing a relationship of a developing contrast voltage and a toner electrification amount according to an embodiment.

FIG. 10 is an exemplary diagram showing a relationship of a developing contrast voltage and a correction coefficient according to an embodiment.

FIG. 11 is an exemplary flow chart showing a schematic image quality maintenance control process sequence according to an embodiment.

FIG. 12 is an exemplary diagram showing a relationship of a grid bias voltage, a non light exposure portion potential, a light exposure potential, and a developing bias voltage according to an embodiment.

FIG. 13 is an exemplary diagram showing a relationship of a pattern area on a photoconductive drum and a toner attachment amount measuring portion 44 according to an embodiment.

FIG. 14 is a diagram showing an exemplary carrier supply time correction coefficient database managed in a correction coefficient database according to an embodiment.

FIG. 15 is an exemplary flow chart showing an operation sequence of a carrier supply time control portion according to an embodiment.

### DETAILED DESCRIPTION

In general, according to one embodiment, an image forming apparatus includes a developing unit configured to store a developer comprising a toner and a carrier and to form a developer image; a toner attachment amount detection portion configured to detect an attachment amount of a toner formed on a photoconductor or an intermediate transfer body; a developing bias voltage change portion configured to change a plurality of developing bias voltages including a developing contrast voltage in a manner that the detected attachment amount of the toner becomes a value in a predetermined range; a carrier supply time correction portion configured to correct a carrier supply time in response to the value of the changed developing contrast voltage; and a carrier supply portion configured to supply a carrier in a corrected carrier supply time at a predetermined timing.

Hereinafter, an embodiment of the present invention will be described.

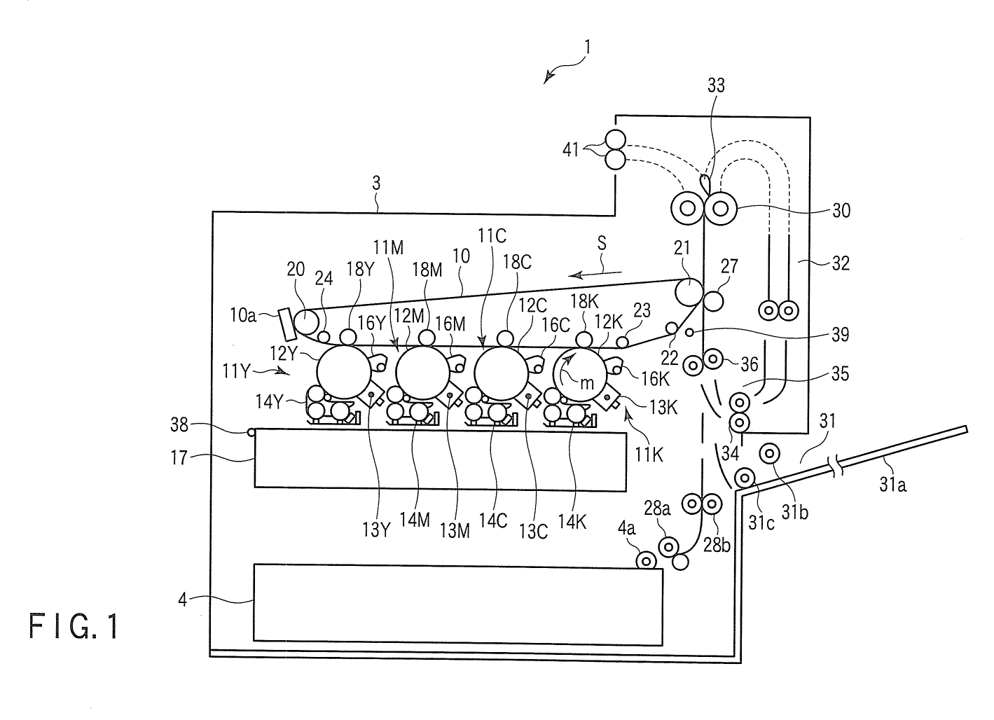

FIG. 1 is an exemplary schematic configuration diagram of a color printer 1 which is an image forming apparatus according to an embodiment. The color printer 1 is of a four-drum tandem type. A process velocity is 150 mm/S.

The color printer 1 includes a paper discharge portion 3 at an upper part. The color printer 1 has an image forming unit 11 at a lower side of a intermediate transfer belt 10. The image forming unit 11 includes four process units 11Y, 11M, 11C and 11K disposed in parallel along the intermediate transfer belt 10. The process units 11Y, 11M, 11C and 11K form toner images of yellow (Y), magenta (M), cyan (C), and black (K), respectively.

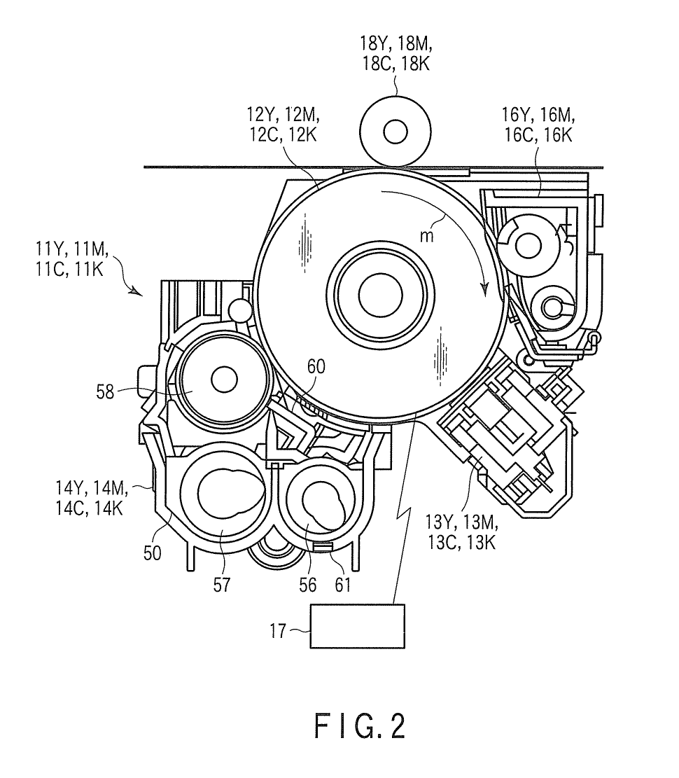

FIG. 2 shows an exemplary detailed configuration diagram of the respective process units 11Y, 11M, 11C and 11K according to an embodiment. The respective process units 11Y, 11M, 11C and 11K have photoconductor drums 12Y, 12M, 12C and 12K that are image carriers, respectively. The respective photoconductor drums 12Y, 12M, 12C and 12K can rotate in an arrow m direction. Around the respective photoconductor drums 12Y, 12M, 12C and 12K, electrification chargers 13Y, 13M, 13C and 13K, developing apparatuses 14Y, 14M, 14C and 14K, and photoconductor cleaners 16Y, 16M, 16C, and 16K are disposed along a rotational direction. In the respective electrification chargers 13Y, 13M, 13C and 13K, the respective drums 12Y, 12M, 12C, and 12K are equally electrified to negative (−).

Between from the electrification chargers 13Y, 13M, 13C and 13K to the developing apparatuses 14Y, 14M, 14C and 14K around the respective photoconductor drums 12Y, 12M, 12C and 12K, the respective exposure lights are emitted by a laser exposure apparatus 17. By the emission of the exposure light, electrostatic latent image is formed on the respective photoconductor drums 12Y, 12M, 12C and 12K. The respective electrification chargers 13Y, 13M, 13C and 13K and the laser exposure apparatus 17 constitute a latent image forming portion.

The respective developing apparatuses 14Y, 14M, 14C and 14K develop the electrostatic latent image on the photoconductor drums 12Y, 12M, 12C and 12K. The respective developing apparatuses 14Y, 14M, 14C and 14K perform the development by the use of the two component developer having the respective toners and carriers of yellow (Y), magenta (M), cyan (C), and black (K) that are the developers.

The intermediate transfer belt 10 is spanned by a backup roller 21, a driven roller 20 and first to third tension rollers 22 to 24, and rotates in an arrow s direction.

The intermediate transfer belt 10 faces and comes into contact with the photoconductor drums 12Y, 12M, 12C and 12K. At positions of the intermediate transfer belt 10 facing the photoconductor drums 12Y, 12M, 12C and 12K, primary transfer rollers 18Y, 18M, 18C and 18K are provided. The respective primary transfer rollers 18Y, 18M, 18C and 18K primarily transfer the toner images formed on the respective photoconductor drums 12Y, 12M, 12C and 12K to the intermediate transfer belt 10.

The respective photoconductor cleaners 16Y, 16M, 16C and 16K remove the surface potential remaining on the respective photoconductor drums 12Y, 12M, 12C and 12K after the primary transfer. The respective photoconductor cleaners 16Y, 16M, 16C and 16K remove and collect the residual toners on the respective photoconductor drums 12Y, 12M, 12C and 12K.

A secondary transfer roller 27 is disposed at a secondary transfer portion which is a transfer position supported by the backup roller 21 of the intermediate transfer belt 10. In the secondary transfer portion, a predetermined secondary transfer bias is applied to the backup roller 21. When the sheet paper passes between the intermediate transfer belt 10 and the secondary transfer roller 27, the toner image on the middle transfer roller belt 10 is secondarily transferred onto the sheet paper. The sheet paper P is fed from a paper feeding cassette 4 or a manual feed mechanism 31. After the secondary transfer is finished, the middle transfer roller belt 10 is cleaned by a belt cleaner 10a. At a position facing the tension roller 22, a toner attachment amount meter 39 for measuring the toner attachment amount on the intermediate transfer belt is provided.

Between from the paper feeding cassette 4 to the secondary transfer roller 27, a pickup roller 4a, a separation roller 28a, a transport roller 28b, and a resist roller pair 36 are provided. Between from a manual feed tray 31a of the manual feed mechanism 31 to the resist roller pair 36, a manual feed pickup roller 31b and a manual feed separation roller 31c are provided. In addition, a fixing apparatus 30 is provided at a downstream of the secondary transfer portion along a direction of a longitudinal transport path 34. The fixing apparatus 30 fixes the toner image, which is transferred onto the sheet paper P by the secondary transfer portion, to the sheet paper P. At the downstream of the fixing apparatus 30, a gate 33, which divides the sheet paper into a paper discharge roller 41 direction or a re-transport unit 32 direction, is provided. The sheet paper guided to the paper discharge roller 41 is discharged to the paper discharge portion 3. The sheet paper guided to the re-transport unit 32 is guided in the secondary transfer roller 27 direction again.

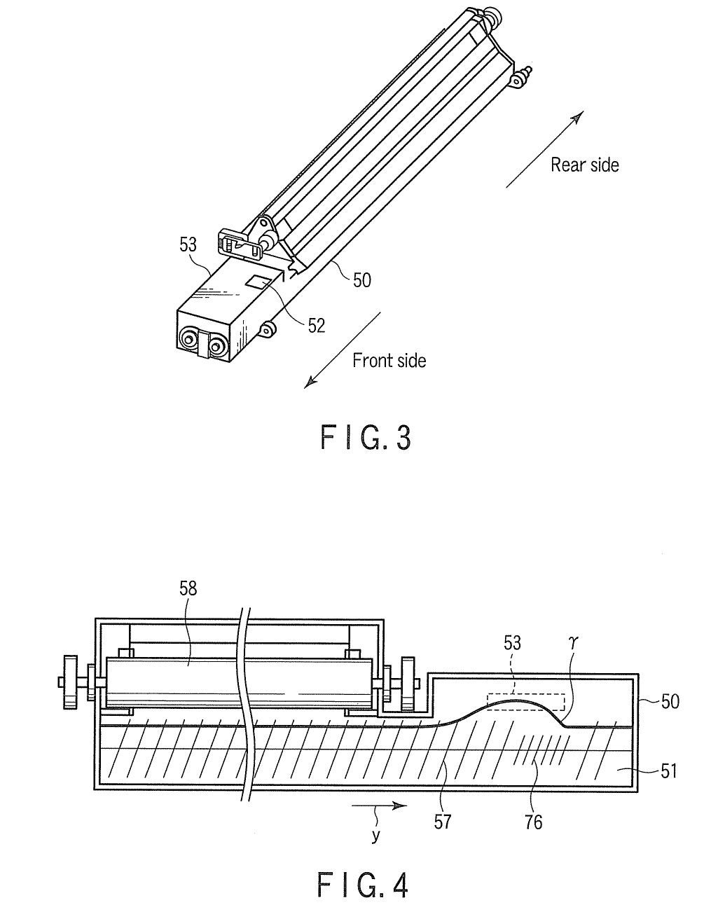

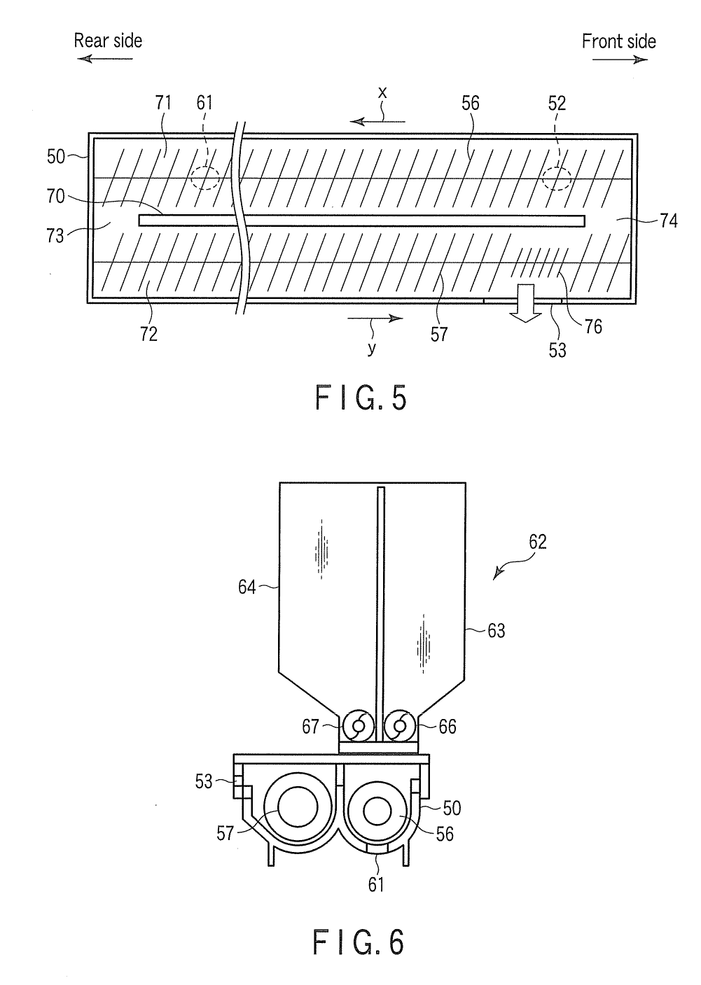

Next, the developing apparatuses 14Y, 14M, 14C and 14K will be described with reference to FIGS. 2 to 7. Since the developing apparatuses 14Y, 14M, 14C and 14K have the same configuration, the description will be made using the common reference numerals. The respective developing apparatuses 14Y, 14M, 14C and 14K have a case 50 that is a developing container, a developing roller 58, a first screw 56 and a second screw 57 that are transport portions, a restriction blade 60, and a toner concentration sensor 61.

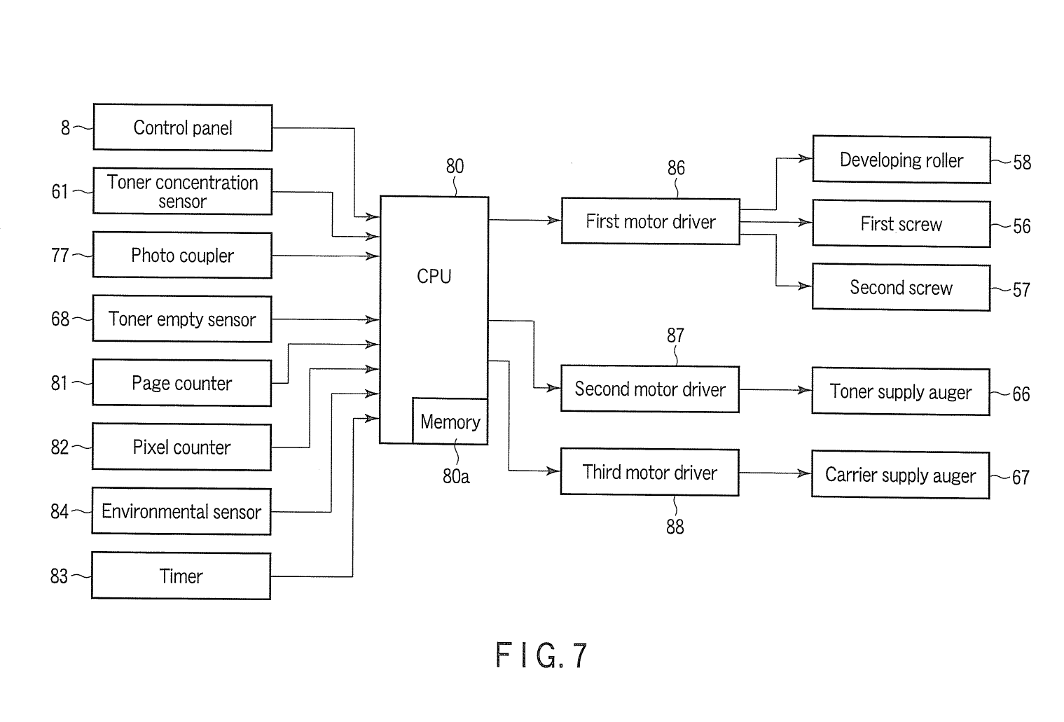

FIG. 7 is an exemplary block diagram of a control system for controlling a new carrier supply to the respective developing apparatuses according to an embodiment. To an input side of a CPU 80, which is a control portion that controls the overall color printer 1 and controls the supply amount of the carrier, there are connected a control panel 8, a toner concentration sensor 61, a toner empty sensor 68 for detecting that the toner cartridge 63 is empty, a photo coupler 77 for detecting the revolution of the developing roller 58, a page counter 81 for cumulatively counting the printing number (printing sheet number) of the color printer 1, a pixel counter 82 for detecting the printing rate of the image, a timer 83, and an environmental sensor 84. The printing rate is defined by a percentage of an area to be printed and a printed area.

First to third motor drivers 86 to 88 are connected to the output side of the CPU 80. The first motor driver 86 drives the developing roller 58, the first screw 56 and the second screw 57. The second motor driver 87 drives a toner supply auger 66. The third motor driver 88 drives a carrier supply auger 67.

A case 50 contains the developer 51 having the toner and the carrier. The respective developers 51 of the developing apparatuses 14Y, 14M, 14C and 14K differ in colors, respectively. A developer supply port 52 is formed on an upper part of a front side of the case 50. A developer supply unit 62 is provided at the front side of the case 50. The developer supply unit 62 integrally has a toner cartridge 63 and a carrier cartridge 64. The toner cartridge 63 contains a new toner for supply that is a toner supply portion. The carrier cartridge 64 contains a new carrier for supply that is a carrier supply portion. On a bottom part of the toner cartridge 63, a toner supply auger 66, which supplies a new toner to the developer supply port 52, is provided. On a bottom portion of the carrier cartridge 64, a carrier supply auger 67, which supplies a new carrier to the developer supply port 52, is provided.

The toner supply auger 66 rotates so as to supply a predetermined amount of toner by the detection result of the toner concentration sensor 61. Although the details will be described later, deterioration property of the developer 51 in the case 50 is detected in the present embodiment. The carrier supply auger 67 rotates so as to supply a predetermined amount of carrier depending on the characteristic variation of the developer 51 in the case 50. The restriction blade 60 almost regularly controls the height of the two component developer.

The toner concentration sensor 61 is disposed at the lower part of a rear side of the first screw 56. It is desirable that the toner concentration sensor 61 be arranged separately from the developer supply port 52 in the case 50. By the arrangement, the toner concentration sensor 61 improves accuracy of the measurement of the toner concentration in the developer 51. The toner concentration sensor 61 uses, for example, a magnetic permeability, sensor or the like. The detection result which is an output of the toner concentration sensor 61 is displayed as the voltage value. When the toner concentration of the developer 51 in the case 50 fluctuates, the output value of the toner concentration sensor 61 fluctuates. Furthermore, if the electrification amount of the toner of the developer 51 is fluctuated, the output value of the toner concentration sensor 61 is fluctuated.

When the toner concentration of the developer 51 in the case 50 declines, the toner concentration sensor 61 inputs the detection result into the CPU 80. The CPU 80 drives the toner supply auger 66 depending on the detection result, thereby supplying a new toner in the toner cartridge 63. As a result, toner concentration of the developer 51 in the case 50 is regularly maintained.

A developer discharge port 53, which is the discharge portion, is formed at a side portion of the front side of the case 50. The new toner and carrier are supplied, whereby, as the volume in the case 50 increases, the excessive developer is discharged from the developer discharge port 53 and is collected. As a result, in the case 50, the amount of the developer 51 is regularly maintained. Concurrently, in the developer 51 in the case 50, the deteriorated old carrier is gradually replaced with the new carrier.

The developing roller 58 is rotatably provided in the case 50. The developing roller 58 supplies the toner to the electrostatic latent image, which is formed on the respective photoconductor drums 12Y, 12M, 12C, and 12K, thereby forming the toner image. The inner part of the case 50 is partitioned by a partition plate 70 along an axial direction of the respective photoconductor drums 12Y, 12M, 12C, and 12K. The inner part of the case 50 is partitioned into a stirring transport chamber 71 and a stirring supply chamber 72 by the partition plate 70. In the stirring transport chamber 71, the new toner and the new carrier supplied from the developer supply port 52 and the developer 51 in the case 50 are stirred by the first screw 56 and are transported in an arrow x direction. As a result, the toner of the developer 51 is electrified.

The developer 51, which is stirred and transported by the first screw 56, passes through a first passage portion 73 of a rear side of the partition plate 70 and is supplied to the stirring supply chamber 72. In the stirring supply chamber 72, the developer 51 is stirred and transported by the second screw 57 in an arrow y direction, thereby being supplied to the developing roller 58.

A discharge screw 76 is formed at a front side of the second screw 57. As shown in FIG. 4, the discharge screw 76 reduces the diameter of the screw and narrows the pitch of the screw to reduce the flow velocity of the developer 51. Thus, as shown by solid line y, the surface of the developer 51 transported in the arrow y direction bulges in the form of a mountain. If the volume of the developer 51 in the case 50 is equal to or less than a predetermined amount, even though the developer 51 bulges by the discharge screw 76, the developer 51 does not reach up to the height of the developer discharge port 53. If the carrier is supplied from the carrier cartridge 64 in this state, the volume of the developer 51 increases. In addition, the discharge screw 76 causes the bulged developer 51 to reach up to the height of the developer discharge port 53. The developer 51 reached the developer discharge port 53 is discharged from the developer discharge port 53. The developer discharge port 53 is disposed so that the peak of the mountain shape of the developer 51, which bulges by the discharge screw 76, coincides with an approximately middle portion of a longitudinal direction of the developer discharge port 53. Thus, the developer, which is excessive by supplying the carrier, is discharged from the developer discharge port 53. The developer 51, which has passed through the discharge screw 76, passes through the second passage portion 74 of the front side of the partition plate 70 and is cyclically transported to the stirring transport chamber 71.

In the color printer 1 of the present embodiment, when performing the image forming, depending on the detection result of the toner concentration sensor 61, in the respective developing apparatuses 14Y, 14M, 14C, and 14K, the new toner is supplied from the toner cartridge 63 to the case 50. Furthermore, depending on the detection result of the deterioration of the carrier of the developer 51, in the respective developing apparatuses 14Y, 14M, 14C, and 14K, the new carrier is supplied from the carrier cartridge 64 to the case 50.

Next, a method of detecting of the deterioration of the carrier to supply the new carrier into the case 50 will be described in detail. In the image forming apparatus, by the use of a method that is called an image quality maintenance control, a developing bias voltage VD or a grid bias voltage VG, which is used at the time of an actual image forming, is determined. In the present embodiment, the deterioration state of the developer is presumed by the use of a developing contrast voltage VC determined in the image quality maintenance control. In addition, the supply amount of the new carrier is corrected based on the presumption value.

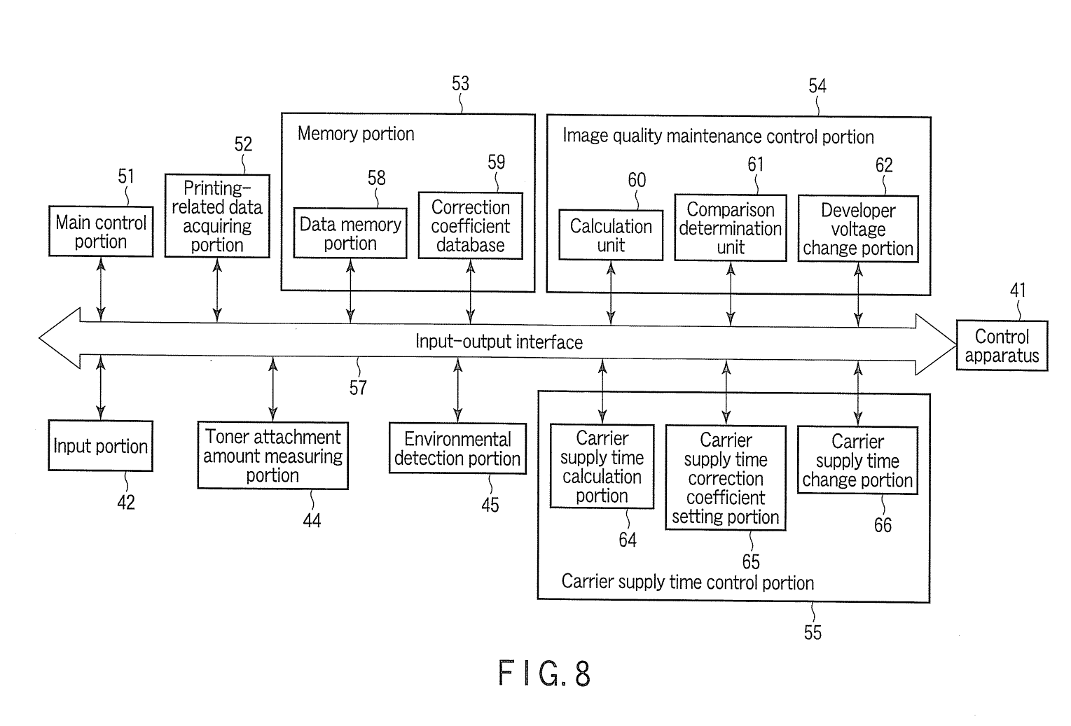

FIG. 8 is a schematic exemplary functional configuration diagram of a control system in an image forming apparatus according to an embodiment. As shown in FIG. 8, an input portion 42, a toner attachment amount measuring portion 44, and an environmental detection portion 45 are connected to the control apparatus 41.

In addition, the control apparatus 41 has a main control portion 51, a printing-related data acquiring portion 52, a memory portion 53, an image quality maintenance control portion 54, a carrier supply time control portion 55, and an input-output interface 57. The input-output interface 57 connects the main control portion 51, the printing-related data acquiring portion 52, the memory portion 53, the image quality maintenance control portion 54, and the carrier supply time control portion 55 to the control apparatus 41.

The main control portion 51 includes a CPU (Central Processing Unit) or a MPU (Micro Processing Unit), a ROM (Read Only Memory), a RAM (Random Access Memory). The main control portion 51 generally controls the image forming apparatus 1 by creating and supplying various control signals.

The printing-related data acquiring portion 52 acquires printing-related data from the input portion 42, or from an external device (not shown) via an electric cable or the like, by the operation of the display panel, button or the like by an user. In addition, the printing-related data acquiring portion 52 provides the acquired printing-related data to the data memory portion 58 of the memory portion 53.

The memory portion 53 includes a data memory portion 58 and a correction coefficient database 59. The data memory portion 58 acquired the printing-related data provided from the printing-related data acquiring portion 52 and stores the acquired printing-related data. In addition, the data memory portion 58 properly provides various data stored in the respective portions of the image forming apparatus 1 according to instructions of the main control portion 51. In the correction coefficient database 59, an environmental condition such as a relative humidity, an operation condition such as a voltage, and a correction coefficient of the carrier supply time are correlated and registered in advance.

The image quality maintenance control portion 54 includes a calculation unit 60, a comparison determination unit 61, and a developing voltage change portion 62.

The calculation unit 60 calculates the developing contrast voltage VC and a background voltage VBG serving as the standard based on the coefficients K1 to K4 which are stored in the data memory portion 58 as a known data in advance. Herein, the coefficients K1 to K4 are constants when a light exposure portion potential VL and a non light exposure portion potential VO are indicated by the grid bias voltage VG. The calculation portion 60 calculates the developing contrast voltage VC and the background voltage VBG using the light exposure portion potential VL and the non light exposure portion potential VO. In addition, the calculation portion 60 calculates the grid bias voltage VG and the developing bias voltage VD corresponding to the calculated contrast voltage VC and background voltage VBG.

The comparison determination portion 61 compares and determines the measurement data of the toner attachment amount provided from the toner attachment amount measuring portion 44 and data relating to the standard value of the toner attachment amount stored in the data memory portion 58, thereby providing the comparison determination results to the calculation portion 60.

Furthermore, the calculation portion 60 calculates the deviation based on the comparison determination results provided from the comparison determination portion 61 and calculates the developing contrast voltage VC, the standard background voltage VBG, the grid bias voltage VG, and the developing bias voltage VD based on the calculated deviation.

The developing voltage change portion 62 changes the developing contrast voltage VC, the background voltage VBG, the grid bias voltage VG, and the developing bias voltage VD based on the calculation results in the calculation portion 60. The developing voltage change portion 62 provides the data memory portion 58 with data relating to the developing contrast voltage VC, the background voltage VBG, the grid bias voltage VG, and the developing bias voltage VD to be actually applied.

The toner attachment amount measuring portion 44 includes, for example, the toner attachment amount meter 39 of FIG. 1, measures the toner attachment amount attached to the photoconductor drum 12 or the intermediate transfer belt 10 according to the instructions of the main control portion 51, and provides the image quality maintenance control portion 54 with the measurement data of the toner attachment amount.

The environmental detection portion 45 includes, for example, the environmental sensor 38 of FIG. 1, detects the temperature or the relative humidity in the image forming apparatus 1 according to the instructions of the main control portion 51, and creates the environmental detection signal based on the detected temperature or relative humidity. The environmental detection portion 45 provides the respective portions of the control apparatus 41 with the environmental detection signal. The environmental detection signal includes environmental data such as the temperature or the relative humidity in the image forming apparatus 1.

The carrier supply time control portion 55 includes the carrier supply time calculation portion 64, the carrier supply time correction coefficient setting portion 65, and the carrier supply time change portion 66. The carrier supply time control portion 55 changes the supply time of the carrier based on the operation results in the image quality maintenance control portion 54. The details of the operation of the carrier supply time control portion 55 will be described later.

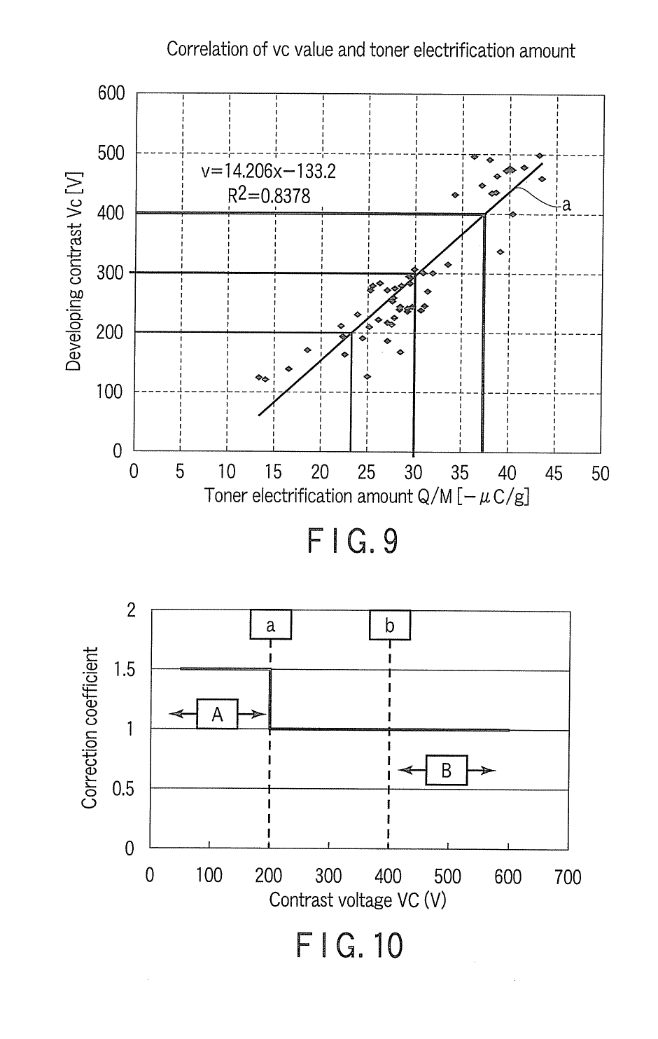

FIG. 9 is an exemplary diagram showing a relationship of the developing contrast voltage and the toner electrification amount according to an embodiment. As shown by a solid line a in FIG. 9, between the developing contrast voltage VC and the toner electrification amount, a correlation, which has a predetermined width and is linear, is recognized. That is, when the toner electrification amount is small, a low developing contrast voltage VC is sufficient. On the contrary, when the toner electrification amount is large, a high developing contrast voltage VC is necessary.

However, in the image quality maintenance control process, the developing contrast voltage VC for obtaining a predetermined toner attachment amount is required. In that case, by the use of the correlation of the developing contrast voltage VC and the toner electrification amount shown in FIG. 9, it is possible to predict that, when the developing contrast voltage VC calculated by the image quality maintenance control process is low, the toner electrification amount becomes smaller, and when the developing contrast voltage VC is high, the toner electrification amount becomes larger. Thus, by grasping the developing contrast voltage VC, the toner electrification amount, that is, deterioration degree of the toner can be grasped. Accordingly, when the developing contrast voltage VC calculated by the image quality maintenance control process is largely deviated from the predetermined standard value, it is determined that the toner electrification amount is also largely deviated from the range of the predetermined standard value, and the carrier supply time can be corrected based on the determination results.

When the carrier supply time is corrected based on the determination result relating to the bulk of the toner electrification amount, specifically, the following correction is performed. That is, when a regular voltage is applied, if the electrification amount of the toner becomes larger, the attachment amount of the toner generally becomes smaller. For this reason, to maintain the toner attachment amount in the regular range, it is necessary to control the voltage depending on the bulk of the electrification amount of the toner.

As shown in FIG. 10, for example, as the lower limit value and the upper limit value of the developing contrast voltage VC in which the toner electrification amount can be regarded to be in the range of the predetermined value, 200 (V) and 400 (V) are set in advance. In addition, the control section is divided into three sections (an optimal electrification area, a low electrification area, and a high electrification area) by the value of the developing contrast voltage VC.

The optimal electrification area is an area in which the electrification amount of the toner can be regarded to be in the range of the predetermined value, and sets the range from 200 (V) to 400 (V) as the range (a-b section) of the developing contrast voltage VC. The low electrification area is an area in which the electrification amount of the toner is lower than the range of the predetermined value, and sets the range of less than 200 (V) as the range (A section) of the developing contrast voltage VC. The high electrification area is an area in which the electrification amount of the toner is larger than the range of the predetermined value, and sets the range larger than 400 (V) as the range (B section) of the developing contrast voltage VC.

In regard to the deterioration of the carrier, there are various types, for example, a case where a coat agent of the carrier surface is peeled off, a case where an external additive with a low resistance such as titanium dioxide included in the toner is attached, so that the electrification of the toner drops, a case where resin or an external additive with a high resistance included in the toner is attached, so that the electrification amount of the toner rises or the like.

In the following embodiments, a case where the electrification amount drops by the deterioration of the carrier will be described.

In the case of an environmental condition of FIG. 10, it is considered that, in the a-b section which is the optimal electrification area and the B section which is the high electrification area, the carrier does not deteriorate. Therefore, the carrier supply time correction coefficient is set to 1.0. The supply of the carrier is performed at the supply time which is obtained by multiplying the normal carrier supply time by the carrier supply time correction coefficient 1.0. Thus, in this case, the carrier amount supplied at the time of supplying is not changed.

In the A section that is the low electrification area, it is considered that the carrier deteriorates. Therefore, the carrier supply time correction coefficient is set to a value larger than 1.0, e.g., 1.5. The carrier is supplied only at the supply time which is obtained by multiplying the normal carrier supply time by the carrier supply time correction coefficient 1.5. Thus, in this case, the carrier amount supplied at the time of supplying increases 1.5 times the ordinary amount.

When the carrier deteriorates, since the new carriers are supplied in a greater amount than the ordinary time, the degree of the deterioration is improved, which makes it possible to maintain a satisfactory developer performance. The carrier supply time correction coefficient is a value that fluctuates by the environmental condition such as the temperature or the relative humidity.

Hereinafter, the carrier supply time control process using the correlation of the developing contrast voltage VC and the toner electrification amount will be described.

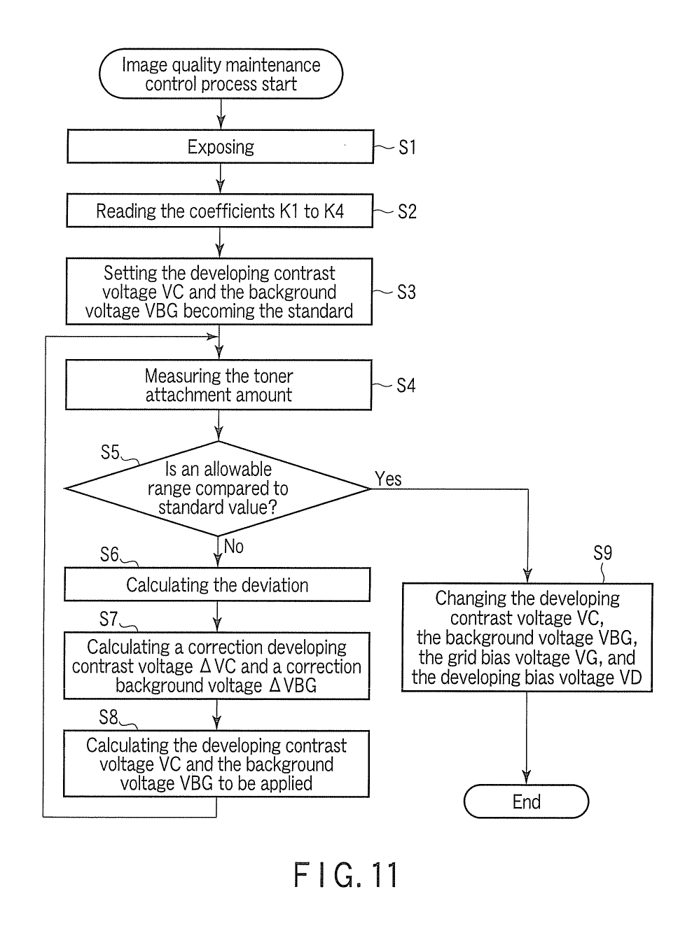

FIG. 11 is a flow chart showing a schematic image quality maintenance control process sequence. The image quality maintenance control process is carried out when the image forming apparatus 1 is in a predetermined timing. The predetermined timing is the timing in which, when the image forming apparatus 1 is activated, so that the fixing device completes a warm-up process up to a predetermined temperature, or after, the image forming apparatus 1 performs the last image quality maintenance control process, a predetermined number of copies, for example, one thousand copies are printed.

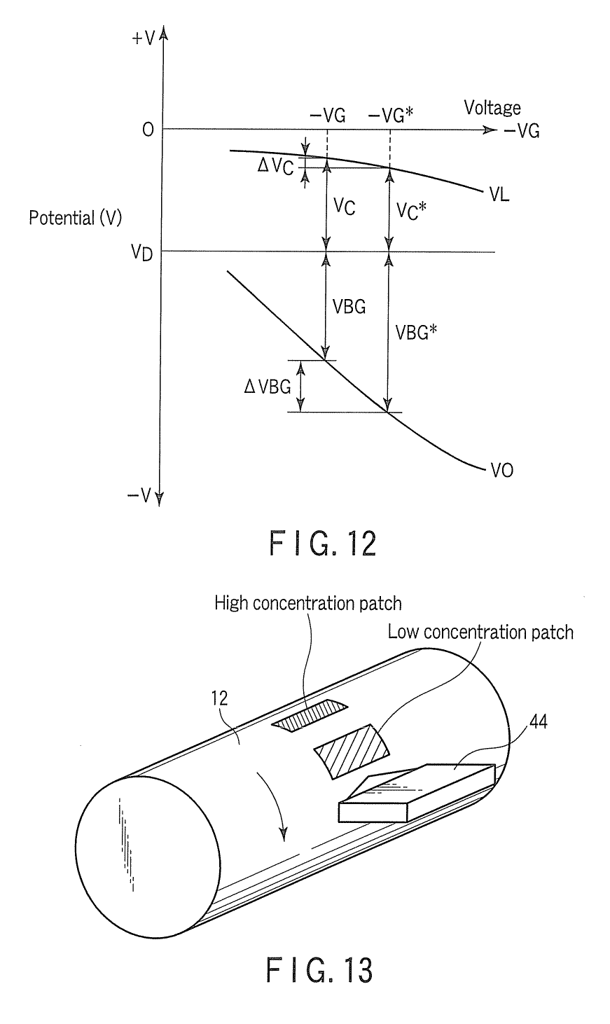

In Act S1, the main control portion 51 exposes the laser exposure apparatus 17 in two gradation patterns of high concentration and low concentration for the toner attachment amount measurement on the photoconductor drum 12. FIG. 12 is an exemplary diagram showing a relationship of a grid bias voltage VG, a non exposure portion potential VO, an exposure portion potential VL, and a developing bias voltage VD according to an embodiment. The grid bias voltage VG is output from a grid electrode of the electrification charger 13. The non exposure portion potential VO is a surface potential of the photoconductor drum 12. The exposure portion potential VL is a surface potential of the photoconductor drum 12 which is attenuated by being entirely exposed by a regular light amount via the laser exposure apparatus 17. In the case of the example of FIG. 12, the polarity of the voltage is negative due to the reverse development.

As shown in FIG. 12, when the grid bias voltage VG increases (changes in a left direction of the drawing), absolute values of the non exposure portion potential VO and the exposure portion potential VL decrease, respectively (changes in an upper direction of the drawing). The exposure portion potential VL and the non exposure portion potential VO relative to the grid bias voltage VG can be indicated by formulas (1) and (2) by a linear approximation.

VO(VG)=K1×VG+K2 formula (1)

VL(VG)=K3×VG+K4 formula (2)

Herein, symbols K1 to K4 are coefficients. VO, VL, and VG are absolute values. VO (VG) and VL (VG) show that VO and VL are indicated by variable VG.

Generally, the toner attachment amount (developing concentration) is changed by the relationship of three values of the developing bias voltage VD, the exposure portion potential VL, and the non exposure portion potential VO. The developing contrast voltage VC and the background voltage VBG are indicated by formulas (3) and (4)

$$\begin{matrix}\begin{matrix}VC = VD ( VG ) - VL ( VG ) \\ = VD ( VG ) - K 3 \times VG - K 4\end{matrix} & formula ( 3 ) \\ \begin{matrix}VBG = VO ( VG ) - VD ( VG ) \\ = K 1 \times VG + K 2 - VD ( VG )\end{matrix} & formula ( 4 )\end{matrix}$$

Herein, VD (VG) shows the bulk of the developing bias voltage VD relative to an arbitrary grid bias voltage VG.

The developing contrast voltage VC mainly relates to the concentration of the solid color portion, and the background voltage VBG mainly relates to the concentration of the low concentration portion of a multi gradation method using a pulse width modulation. Thus, it is possible to change the toner attachment amount by the developing contrast voltage VC and the background voltage VBG.

Herein, when both sides of formulas (3) and (4) are added to obtain VG, formula (5) can be obtained. In addition, when VD is obtained from the formula (4), formula (6) can be obtained.

VG−(VC+VBG−K2+K4)/(K1−K3) formula (5)

VD=K1×VG+K2−VBG formula (6)

By formulas (5) and (6), the grid bias voltage VG and the developing bias voltage VD are indicated by the use of the developing contrast voltage VC and the background voltage VBG.

In this manner, if the coefficients K1 to K4, which indicate the relationship of the exposure portion potential VL and the non exposure portion potential VO relative to the grid bias voltage VG, are already known, by determining the developing contrast voltage VC and the background voltage VBG, it is possible to primarily calculate the grid bias voltage VG and the developing bias voltage VD by the use of formulas (5) and (6) accordingly.

Therefore, the developing contrast voltage VC and the background voltage VBG are determined on the basis of the coefficients K1 to K4 which show the relationship of the exposure portion potential VL and the non exposure portion potential VO relative to the grid bias voltage VG stored in the data memory portion 58 as known data in advance.

In Act S2 of FIG. 11, the calculation portion 60 of the image maintenance control portion 54 reads the coefficients K1 to K4 stored in the data memory portion 58 as the known data in advance. In Act S3, the calculation portion 60 calculates the developing contrast voltage VC and the background voltage VBG serving as the standard based on the read coefficients K1 to K4, and calculates the grid bias voltage VG and the developing bias voltage VD corresponding to the developing contrast voltage VC and the background voltage VBG serving as the calculated standard.

The main control portion 51 controls the respective portions of the image forming apparatus 1, can carries out the developing treatment based on the developing contrast voltage VC and the background voltage VBG serving as the calculated standard, and the grid bias voltage VG and the developing bias voltage VD corresponding to these. That is, the main control portion 51 forms a high concentration pattern area (a high concentration patch) corresponding to the gradation data of the high concentration pattern and a low concentration pattern area (a low concentration patch) corresponding to the gradation pattern of the low concentration with a lower density than the high concentration pattern, on the photoconductor drum 12.

FIG. 13 is a diagram showing a relationship of a pattern area and a toner attachment amount measurement portion 44 on the photoconductor drum.

In Act S4 of FIG. 11, after the gradation patterns of the high concentration and the low concentration irradiated on the photoconductor drum 12 are developed by the developing apparatus 14, the toner attachment amount measurement portion 44 measures the toner attachment amount on the photoconductor drum 12 in synchronous with the movement of the gradation pattern to a measurable position, and provides the comparison determination portion 61 with the measurement data of the toner attachment amount.

In Act S5, the comparison determination portion 61 acquires the measurement data of the toner attachment amount provided from the toner attachment amount measurement portion 44, and reads a predetermined standard value of the toner attachment amount stored in the data memory portion 58 in advance. The comparison determination portion 61 refers to a predetermined standard value of the read toner attachment amount, compares the standard value based on the measurement data of the acquired toner attachment amount, and determined whether or not the toner permissible amount is in an allowable range. For example, it is determined whether or not the measurement values of the toner attachment amount of the high concentration pattern and the low concentration pattern of the toner are in a predetermined range. When it is determined that the measurement value of the toner attachment amount is not in the allowable range, based on the measurement data of the acquired toner attachment amount, the comparison determination portion 61 provides the calculation portion 60 with the comparison determination results.

In Act S6, the calculation portion 60 calculates the deviation based on the comparison determination results provided from the comparison determination portion 61. In Act S7, the calculation portion 60 calculates a correction developing contrast voltage ΔVC and a correction background voltage ΔVBG based on the calculated deviation. The calculated correction developing contrast voltage ΔVC and correction background voltage ΔVBG are, for example, shown in FIG. 12. In Act S8, the calculation portion 60 calculates the developing contrast voltage VC and the background voltage VBG to be applied based on the developing contrast voltage VC becoming the standard, the background voltage VBG becoming the standard, and the calculated correction developing contrast voltage ΔVC and correction background voltage ΔVBG, and calculates the grid bias voltage VG and the developing bias voltage VD corresponding to these. Herein, setting the combination of the developing contrast voltage to be applied and the background voltage to (VC, VBG) or to (VC*, VBG*) differs according to the value of the deviation.

Thereafter, returning to Act S4, the treatments after Act S4 are repeatedly carried out. That is, the main control portion 51 controls the respective portions of the image forming apparatus 1, performs the developing treatment based on the calculated developing contrast voltage VC and the background voltage VBG, and the grid bias voltage VG and developing bias voltage VD corresponding to these, and forms the high concentration pattern area (the high concentration patch) and the low concentration pattern area (the low concentration patch) on the photoconductor drum 12. The toner attachment amount is measured by the toner attachment amount measurement portion 44, and the same treatment is repeated until it is determined that the toner attachment amount is in the allowable range compared to the predetermined standard value. As a result, it is possible to calculate the optimal developing contrast voltage VC and background voltage VBG, and grid bias voltage VG and developing bias voltage VD corresponding to these.

In the case of Yes in Act S5, that is; in the case where it is determined that the toner attachment amount is in the allowable range based on the measurement data of the acquired toner attachment amount, the comparison determination portion 61 provides the calculation portion 60 with the comparison determination results. The calculation portion 60 recognizes that the toner attachment amount is in the allowable range compared to the predetermined standard value based on the comparison determination results provided from the comparison determination portion 61, and provides the developing voltage change portion 63 with the current developing contrast voltage VC and background voltage VBG, and the grid bias voltage VG and the developing bias voltage VD corresponding to these.

In Act S9, the developing voltage change portion 62 changes the developing contrast voltage VC, the background voltage VBG, the grid bias voltage VG, and the developing bias voltage VD, based on the calculation results provided from the calculation portion 60. The developing voltage change portion 62 provides the data memory portion 58 with data relating to the changed developing contrast voltage VC, background voltage VBG, grid bias voltage VG, and developing bias voltage VD.

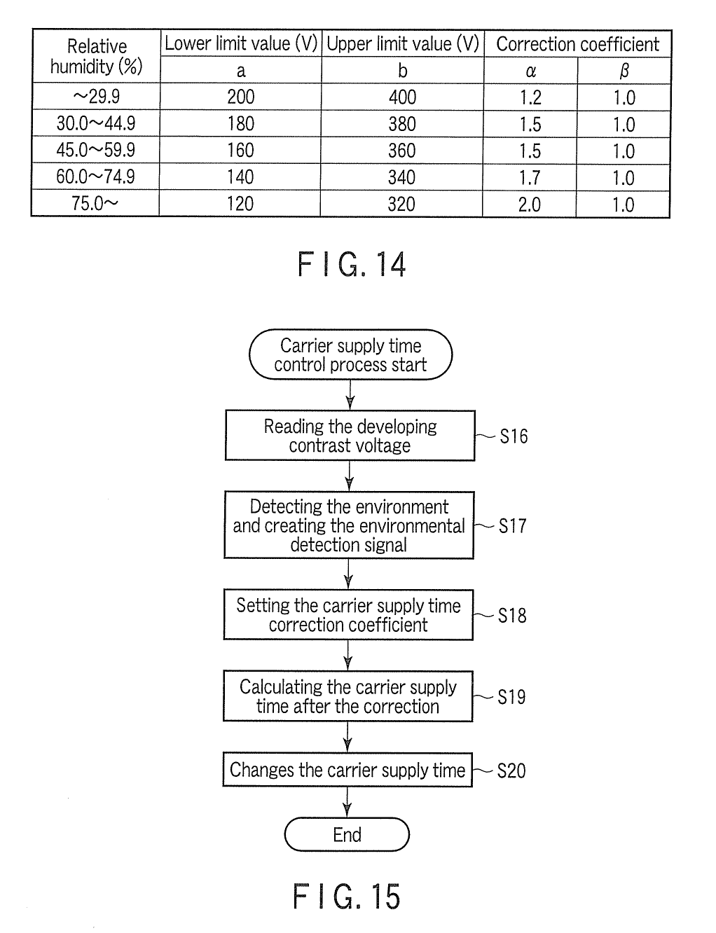

FIG. 14 is an exemplary carrier supply time correction coefficient database managed in a correction coefficient database 59 according to an embodiment. In a first row to fifth row of the carrier supply time correction coefficient database of FIG. 14, “relative humidity (%)”, “lower limit value (V)”, “upper limit value (V)”, “α”, and “β” are described. “Relative humidity (%)” is a value of the relative humidity in the image forming apparatus 1. “Lower limit value (V)” is a lower limit value of the developing contrast voltage VC in which the electrification amount of the toner can be regarded to be in the range of the predetermined value. “Upper limit value (V)” is an upper limit value of the developing contrast voltage VC in which the electrification amount of the toner can be regarded to be in the range of the predetermined value. “α” is a correction coefficient of the carrier supply time in the low electrification area. “β” is a correction coefficient of the carrier supply time in the high electrification area.

In the case of a first line of the database of FIG. 14, “relative humidity (%)” is “up to 29.9(%)” and shows that the value of the relative humidity in the image forming apparatus 1 is “up to 29.9(%)”. “Lower limit value (V)” is “200 (V)” and shows that the lower limit value of developing contrast voltage VC in which the electrification amount of the toner can be regarded to be in the range of the predetermined value is “200 (V)”. “Upper limit value (V)” is “400 (V)” and shows that the upper limit value of developing contrast voltage VC in which the electrification amount of the toner can be regarded to be in the range of the predetermined value is “400 (V)”. “α” is “1.2” and shows that the correction coefficient of the carrier supply time in the low electrification area is “1.2”. “β” is “1.0” and shows that the correction coefficient of the carrier supply time in the high electrification area is “1.0”.

In the case of a second line of the database of FIG. 14, “relative humidity (%)” is “30.0 to 49.9(%)” and shows that the value of the relative humidity in the image forming apparatus 1 is “30.0 to 49.9(%)”. “Lower limit value (V)” is “180 (V)” and shows that the lower limit value of developing contrast voltage VC in which the electrification amount of the toner can be regarded to be in the range of the predetermined value is “180 (V)”. “Upper limit value (V)” is “380 (V)” and shows that the upper limit value of developing contrast voltage VC in which the electrification amount of the toner can be regarded to be in the range of the predetermined value is “380 (V)”. “α” is “1.5” and shows that the correction coefficient of the carrier supply time in the low electrification area is “1.5”. “β” is “1.0” and shows that the correction coefficient of the carrier supply time in the high electrification area is “1.0”.

In the case of a third line of the database of FIG. 14, “relative humidity (%)” is “45.0 to 59.9(%)” and shows that the value of the relative humidity in the image forming apparatus 1 is “45.0 to 59.9(%)”. “Lower limit value (V)” is “160 (V)” and shows that the lower limit value of developing contrast voltage VC in which the electrification amount of the toner can be regarded to be in the range of the predetermined value is “160 (V)”. “Upper limit value (V)” is “360 (V)” and shows that the upper limit value of developing contrast voltage VC in which the electrification amount of the toner can be regarded to be in the range of the predetermined value is “360 (V)”. “α” is “1.5” and shows that the correction coefficient of the carrier supply time in the low electrification area is “1.5”. “β” is “1.0” and shows that the correction coefficient of the carrier supply time in the high electrification area is “1.0”.

In the case of a fourth line of the database of FIG. 14, “relative humidity (%)” is “60.0 to 74.9(%)” and shows that the value of the relative humidity in the image forming apparatus 1 is “60.0 to 74.9(%)”. “Lower limit value (V)” is “140 (V)” and shows that the lower limit value of developing contrast voltage VC in which the electrification amount of the toner can be regarded to be in the range of the predetermined value is “140 (V)”. “Upper limit value (V)” is “340 (V)” and shows that the upper limit value of developing contrast voltage VC in which the electrification amount of the toner can be regarded to be in the range of the predetermined value is “340 (V)”. “α” is “1.7” and shows that the correction coefficient of the carrier supply time in the low electrification area is “1.7”. “β” is “1.0” and shows that the correction coefficient of the carrier supply time in the high electrification area is “1.0”.

In the case of a fifth line of the database of FIG. 14, “relative humidity (%)” is “75.0(%) or more” and shows that the value of the relative humidity in the image forming apparatus 1 is “75.0(%) or more”. “Lower limit value (V)” is “120 (V)” and shows that the lower limit value of developing contrast voltage VC in which the electrification amount of the toner can be regarded to be in the range of the predetermined value is “120 (V)”. “Upper limit value (V)” is “320 (V)” and shows that the upper limit value of developing contrast voltage VC in which the electrification amount of the toner can be regarded to be in the range of the predetermined value is “320 (V)”. “α” is “2.0” and shows that the correction coefficient of the carrier supply time in the low electrification area is “2.0”. “β” is “1.0” and shows that the correction coefficient of the carrier supply time in the high electrification area is “1.0”.

FIG. 15 is an exemplary flow chart showing an operation sequence of a carrier supply time control portion 55 according to an embodiment.

In Act S16, the carrier supply time correction coefficient setting portion 65 reads data relating to the developing contrast voltage VC stored in the data memory portion 58. In Act S17, the environmental detection portion 45 detects the environment (temperature, relative humidity, etc.) in the image forming apparatus 1 according to the instructions of the main control portion 51, creates the environmental detection signal, and provides the carrier supply time correction coefficient setting portion 65 with the signal. The environmental detection signal includes data relating to the environment in the image forming apparatus 1.

In Act S18, the carrier supply time correction coefficient setting portion 65 refers to the carrier supply time correction coefficient database managed in the read correction coefficient database 59, and sets the carrier supply time correction coefficient based on data relating to the read developing contrast voltage VC and the environmental detection signal provided from the environmental detection portion 45.

Specifically, when the relative humidity is 35(%) and the developing contrast voltage VC is 160 (V), the carrier supply time correction coefficient corresponds to the second line in the database of FIG. 14. In addition, since the developing contrast voltage VC is in the low electrification area, the carrier supply time correction coefficient is “1.5”. As a result, it is possible to set the correction coefficient of the carrier supply time according to the toner electrification amount and the environment.

The carrier supply time correction coefficient setting portion 65 provides the carrier supply time calculation portion 64 with data of the set carrier supply time correction coefficient.

In Act S19, the carrier supply time calculation portion 64 acquires the carrier supply time correction coefficient data provided from the carrier supply time correction coefficient setting portion 65, and calculates the carrier supply time after the correction according to the toner electrification amount based on the acquired carrier supply time correction coefficient data and the carrier supply time. That is, the carrier supply time calculation portion 64 calculates the value which is obtained by multiplying the carrier supply time by the carrier supply time correction coefficient, and provides the carrier supply time change portion 66 with the calculation results. In Act S20, the carrier supply time change portion 66 changes the carrier supply time based on the calculation results provided from the carrier supply time calculation portion 64.

Furthermore, although the case where the electrification amount declines due to the deterioration of the carrier is described in the above-mentioned case, the present invention can also be applied to a case where the electrification amount increases due to the deterioration of the carrier. In this case, the control is performed so as to change the carrier supply time by the carrier supply time correction coefficient corresponding to the high electrification amount area.

In addition, although the carrier supply time correction coefficient corresponding to the low electrification amount area is set to values different from 1.0 in the above-mentioned case, the carrier supply time correction coefficient corresponding to the low electrification amount area and the high electrification amount area may be set to the values different from 1.0.

In addition, the toner attachment amount meter may measure the toner attachment amount on the intermediate transfer belt 10 as shown in FIG. 1, and may measure the toner attachment amount on the photoconductor drum 12.

Furthermore, when the value of the developing contrast voltage VC deviates from the predetermined limit values (the upper limit value and the lower limit value), information showing that the maintenance is necessary may be output to stop the image forming apparatus.

In addition, although multiplication calculation is performed using the correction coefficient to correct the carrier supply time in the above-mentioned case, an adjustment calculation may be performed using the correction value.

In the image forming apparatus 1 shown in the present embodiment, with reference to carrier supply time correction coefficient database managed in the correction coefficient database 59, on the basis of data relating to the developing contrast voltage VC changed by the image quality maintenance control treatment, and environmental data (data relating to the temperature or the relative humidity) included in the environmental detection signal provided from the environmental detection portion 45, the carrier supply time correction coefficient is set. As a result, when the toner electrification amount greatly deviates from the range of the predetermined standard value, it is possible to correct the carrier supply time based on the set carrier supply time correction coefficient. Thus, it is possible to maintain the very satisfactory developer performance.

In addition, although, in the image forming apparatus 1 shown in the present embodiment, the area is divided into three sections (the optimal electrification area, the low electrification area, and the high electrification area) by the value of the developing contrast voltage VC, so that the correction coefficient is set to the different values for each sections, the present invention is not limited to the case, the area may be divided into two or four sections or more, and the appropriate correction coefficient may be calculated and set according to the value of the developing contrast voltage VC. In this case, at least one section is set to the appropriate electrification area.

In the present embodiment, when the image forming is performed by the color printer 1, the page counter 81 cumulatively counts the image forming sheets and inputs the number of the sheets to the CPU 80. When the detection result of the page counter 81 reaches a predetermined number of image forming sheets, the CPU 80 controls the third motor driver 88. The third motor driver 88 drives the carrier supply auger 67 by a predetermined amount, thereby supplying the carrier in the carrier cartridge 64 to the case 50 by the predetermined amount. In the present embodiment, the capacity of the developer in the case 50 is 400 g, it is necessary to normally supply the carrier at the rate of 4 g whenever the number of print sheets reaches one thousand, and the time necessary for the supply is about 8 seconds. With respect to the supply time, the above-mentioned correction is performed and the carrier is supplied at the supply time after the correction.

As the carrier is supplied and the volume increases, the excessive developer is discharged from the developer discharge port 53. As a result, in the developer 51 in the case 50, the carrier of about 4 g is newly replaced. Thus, in the respective developing apparatuses 14Y, 14M, 14C and 14K, the deterioration of the carrier in the case 50 is suppressed. As a result, the carrier can always maintain the satisfactory property and can sufficiently electrify the toner.

In addition, the respective functions described in the above-mentioned embodiments may be constituted by the use of hardware and may be realized by reading a program, in which the respective functions are described, into a computer using software. Furthermore, the respective functions may be constituted by appropriately selecting any one of the software and hardware.

In addition, the respective functions can be realized by reading the program stored in a recording medium (not shown) into a computer. Herein, if the recording medium in the present embodiment is a recording medium that can record the program and can be read by the computer, the recording type may be any form.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a developing unit configured to store a developer comprising a toner and a carrier and to form a developer image;
a toner attachment amount detection portion configured to detect an attachment amount of a toner formed on a photoconductor or an intermediate transfer body;
a developing bias voltage change portion configured to change a plurality of developing bias voltages including a developing contrast voltage in a manner that the detected attachment amount of the toner becomes a value in a predetermined range;
a carrier supply time correction portion configured to correct a carrier supply time in response to the value of the changed developing contrast voltage; and
a carrier supply portion configured to supply a carrier in a corrected carrier supply time at a predetermined timing.

2. The apparatus according to claim 1, further comprising:
an environmental condition detection portion configured to detect an environmental condition including a relative humidity; and
a database configured to store a correction value to correct the carrier supply time in response to the environmental condition and the developing contrast voltage,
wherein the carrier supply time correction portion extracts the correction value corresponding to the environmental condition detected from the database and detected developing contrast voltage and corrects the carrier supply time using the correction value.

3. The apparatus according to claim 2,
wherein the correction value is a correction coefficient, and
wherein the carrier supply time correction portion calculates the corrected carrier supply time by multiplying the correction coefficient extracted from the database by the carrier supply time.

4. The apparatus according to claim 2,
wherein the environmental condition is the relative humidity.

5. The apparatus according to claim 4,
wherein the correction value is the correction coefficient, and
wherein carrier supply time correction portion calculates the corrected carrier supply time by multiplying the correction coefficient extracted from the database by the carrier supply time.

6. The apparatus according to claim 2,
wherein the developing contrast voltage in the database is divided into at least three sections, and the database stores the correction value for each divided section.

7. The apparatus according to claim 6,
wherein the database stores the correction value that does not change the carrier supply time in response to at least one section among at least three sections.

8. The apparatus according to claim 6,
wherein the database stores the correction value that changes the carrier supply time in response to at least one section among at least three sections.

9. The apparatus according to claim 1, further comprising:
an emergency process portion configured to output information indicating that the value of the detected developing contrast voltage is higher than a predetermined upper limit value or smaller than a predetermined lower limit value, thereby stopping the operation of the image forming apparatus.

10. An image forming method comprising:
detecting an attachment amount of a toner formed on a photoconductor or an intermediate transfer body by the use of a developer comprising a toner and a carrier;
changing a plurality of developing bias voltages including a developing contrast voltage in a manner that the detected attachment amount of the toner becomes a value in a predetermined range;
correcting a carrier supply time in response to the value of the changed developing contrast voltage; and
supplying a carrier in a corrected carrier supply time at a predetermined timing.

11. The method according to claim 10, further comprising:
detecting an environmental condition including a relative humidity; and
storing a correction value, which corrects the carrier supply time in response to the environmental condition and the developing contrast voltage, in the database,
wherein in the correction of the carrier supply time, the correction value corresponding to the environmental condition detected from the database and detected developing contrast voltage is extracted, and the carrier supply time is corrected using the correction value.

12. The method according to claim 11,
wherein the correction value is a correction coefficient, and
wherein, in the correction of the carrier supply time, the corrected carrier supply time is calculated by multiplying the correction coefficient extracted from the database by the carrier supply time.

13. The method according to claim 11,
wherein the environmental condition is the relative humidity.

14. The method according to claim 13,
wherein the correction value is the correction coefficient, and
wherein, in the correction of the carrier supply time, the corrected carrier supply time is calculated by multiplying the correction coefficient extracted from the database by the carrier supply time.

15. The method according to claim 11,
wherein the developing contrast voltage in the database is divided into at least three sections, and the database stores the correction value for each divided section.

16. The method according to claim 15,
wherein the database stores the correction value that does not change the carrier supply time in response to at least one section among at least three sections.

17. The method according to claim 15,
wherein the database stores the correction value that changes the carrier supply time in response to at least one section among at least three sections.

18. The method according to claim 10, further comprising:
outputting information indicating that the value of the detected developing contrast voltage is higher than a predetermined upper limit value or smaller than a predetermined lower limit value, thereby stopping the operation of the image forming apparatus.

19. An image forming apparatus comprising:
developing means for using a developer comprising a toner and a carrier;
toner attachment amount detection means for detecting an attachment amount of a toner formed on a photoconductor or an intermediate transfer body;
developing voltage change means for changing a plurality in voltages including a developing contrast voltage in a manner that the detected attachment amount of the toner becomes a value in a predetermined range;
carrier supply time correction means for correcting a carrier supply time in response to the value of the changed developing contrast voltage; and
carrier supply means for supplying a carrier in a corrected carrier supply time at a predetermined timing.

20. The apparatus according to claim 19, further comprising:
environmental condition detection means for detecting an environmental condition including a relative humidity; and
a database that stores a correction value to correct the carrier supply time in response to the environmental condition and the developing contrast voltage,
wherein the carrier supply time correction unit extracts the correction value corresponding to the environmental condition detected from the database and detected developing contrast voltage and corrects the carrier supply time using the correction value.
